(19) United States
(12) Patent Application Publication
(10) Pub. No.: US 2010/0242872 A1
(43) Pub. Date: Sep. 30, 2010

(54) FUEL FEEDING DEVICE OF A V-SHAPED ENGINE FOR MOTORCYCLE

(75) Inventors: Toshiyuki SATO, Saitama (JP); Masaki Cho, Saitama (JP); Natsue Ogawa, Saitama (JP); Takahiro Imafuku, Saitama (JP)

Correspondence Address: BIRCH STEWART KOLASCH & BIRCH, PO BOX 747, FALLS CHURCH, VA, 22040-0747, US

(73) Assignee: Huntsman Advanced Materials Americas LLC, The Woodlands, TX (US)

(21) Appl. No.: 12/722,245

(22) Filed: Mar. 11, 2010

(30) Foreign Application Priority Data
Mar. 27, 2009 (JP) 2009-080309
Mar. 27, 2009 (JP) 2009-080313
Mar. 27, 2009 (JP) 2009-080314

(51) Int. Cl. F02B 75/22; F02M 37/04; F02M 55/02

(52) U.S. Cl. 123/54.4; 123/509; 123/508; 123/468

(57) ABSTRACT

A motorcycle mounted with a V-shaped engine in which a front bank and a rear bank are disposed like a V-shape and a fuel pump for fuel injection is mounted. The fuel pump is driven by a camshaft of a cylinder head, and mounted on the upside of the cylinder head. The fuel pump is fitted is the cylinder head of the front bank at the back of a head pipe. A fuel chamber is provided between the fuel pump an the injectors, the fuel chamber is disposed lengthways in the vertical direction in the V-bank space K, and a lower end part is disposed facing the sides of the injectors, and connection to the injectors by fuel pipes extending from the lower end part substantially horizontally. With this configuration, the fuel pump does not obstruct other components in the motorcycle, and is protected without a special cover.

### CROSS-REFERENCE TO RELATED APPLICATION

The present application claims priority under 35 U.S.C. §119 to Japanese Patent Application Nos. 2009-080314, 2009-080309, and 2009-080313, each filed Mar. 27, 2009, the entire contents of which are hereby incorporated by reference.

### BACKGROUND OF THE INVENTION

1. Field of the Invention

This invention relates to a fuel feeding device of a V-shaped engine for a motorcycle.

2. Description of Background Art

In the past, a known motorcycle including a fuel pump for fuel injection is so constructed that the fuel pump is provided on the side of a V-shaped engine and the fuel pump is covered and protected from the outside with a cover. The fuel feeding device for feeding fuel to the V-shaped engine, is a so-called common rail system, in which a fuel chamber (a fuel feed rail) common to the respective cylinders is provided, and the fuel chamber is connected to an injector of each cylinder (See JP-A No. 2005-36681.)

JP-A No. 2005-36681 discloses a configuration in which a fuel chamber is extended orthogonal to a crankshaft above between a plurality of cylinders disposed to form a V-bank.

In the above motorcycle of related art, it is necessary to provide a special cover for covering the fuel pump, so that the number of parts is increased. It is desirable to dispose the fuel pump in a place not to cause an obstruction to the disposition of the other accessories.

In the case of providing the fuel chamber between the V-banks as in the fuel feeding device of related art, the space between the V-banks is occupied by the fuel chamber. In the case of providing the fuel chamber parallel to a crankshaft between the V-banks, for example, the fuel chamber occupies the most part of the space in the V-bank, so that in assembling fuel piping to an injector after an engine is assembled, the space for working using a tool cannot be secured. Consequently, it is difficult to dispose the injector in the lower part in the V-bank, whose space becomes smaller in the V-bank.

JP-A No. 2000-204969 discloses another known V-shaped engine is so constructed that between a plurality of cylinders disposed like a V-shape, intake passages to the respective cylinders are provided with eccentricity in the longitudinal direction of a vehicle, and a fuel feed pipe for feeding fuel to a fuel injection valve (an injector) disposed in each intake passage is offset by bending forward and backward according to the eccentric amount of the intake passage.

In the above V-shaped engine of related art, a fuel chamber is provided in a V-bank, and fuel is fed from the fuel chamber by fuel pipes branching to the injectors of the respective cylinders, whereby the space of the V-bank can be effectively utilized for providing a fuel feeding device. The space in the V-bank is, however, limited, so it is very difficult to conduct the work for fitting a plurality of pipes to the fuel chamber.

### SUMMARY AND OBJECTS OF THE INVENTION

Accordingly, one object of the present invention is to dispose a fuel pump to be protected without a special cover and not to cause an obstruction to the disposition of the other parts in a motorcycle including the fuel pump. Another object of the present invention is to enable assembling of fuel piping in a V-bank and dispose an injector in the lower part in the V-bank in a fuel feeding device of a V-shaped engine.

According to an embodiment of the present invention, a motorcycle includes a V-shaped engine having a cylinder block disposed like a V-shape and a fuel pump for fuel injection mounted thereon. The fuel pump is driven by a camshaft of a cylinder head and provided on the upside of the cylinder head, and the cylinder head to which the fuel pump is fitted is a cylinder head of a front bank at the back of a head pipe.

According to this configuration, the fuel pump can be driven by the camshaft, the fuel pump is mounted on the front bank at the back of the head pipe, and the fuel pump is disposed just at the back of the head pipe, so that the fuel pump can be covered with the head pipe and a frame in the vicinity of the head pipe, and the fuel pump can be protected from the external force or the like without a special cover.

Further, since the fuel pump is disposed in a dead space at the back of the head pipe, it does not cause an obstruction to the disposition of the other parts. Further, the fuel pump is mounted in a position hard to see from the outside at the back of the head pipe and the fuel pump can be disposed not to be conspicuous, so that the appearance can be made clear-cut to improve the appearance of a vehicle.

Further, in the above configuration, two camshafts may be provided in front and behind in the cylinder head of the front bank, and the fuel pump may be driven by the front camshaft and disposed above the front camshaft.

According to this configuration, the fuel pump is provided above the front camshaft of the front bank, so that the fuel pump can be disposed just at the back of the head pipe and the fuel pump can be protected from the external force or the like without the special cover by the head pipe and the frame in the vicinity of the head pipe. Further, since the fuel pump can be driven by the camshaft in a close position to the head pipe, it is not necessary to lengthen a driving force transmission path between the camshaft and the fuel pump for disposing the fuel pump at the back of the head pipe.

The cylinder head of the front bank may be disposed at the back of the head pipe and surrounded by a main pipe and a down tube.

In this case, the fuel pump can be protected from the external force and the like by surrounding using the head pipe and the main pipe and the down tube at the back of the head pipe.

Further, a fuel chamber may be provided between the fuel pump disposed on the cylinder head of the front bank and a fuel injector, the fuel chamber may be disposed lengthways in the vertical direction in a V-bank, an upper end part is disposed facing the upside of the cylinder head cover, and connected to the fuel pump by fuel piping raised from the upper end part and extending substantially parallel to the top face of the cylinder head cover, and the fuel piping may be disposed below a gusset pipe.

In this case, the fuel piping is extended parallel along the top face of the cylinder head cover and disposed below the gusset pipe, and surrounded by the top face of the cylinder head cover and the gusset pipe, so that the fuel piping can be protected.

According to an embodiment of the present invention, a V-shaped engine in which a cylinder block and is disposed like a V-shape and includes a fuel feeding device. The fuel feeding device includes an injector to feed fuel from a fuel pump driven by a cam shaft of a cylinder head and mounted on the cylinder head. A fuel chamber is provided between the fuel pump and the injector, the fuel chamber is disposed lengthways in the vertical direction in the V-bank, and a lower end part is disposed facing the side of the injector, and connected to the injector by a fuel pipe extending from the lower end part substantially horizontally.

According to this configuration, the injector in the lower part in the V-bank and the fuel chamber can be connected to each other by the horizontal fuel pipe extended from the lower end part of the fuel chamber, and the fuel chamber is disposed lengthways in the vertical direction in the V-bank, so that a large space can be secured at the side of the fuel chamber in the V-bank. Thus, a tool or the like can be used utilizing the space in the V-bank, and the fuel pipe connecting the fuel chamber and the injector to each other can be assembled so that the injector can be disposed in the lower part in the V-bank.

Further, since the fuel pipe can be removed utilizing the space in the V-bank, access to the injector can be attained without removing the cylinder head so as to improve the maintainability of the fuel feeding device including the injector.

Further, in the above configuration, the fuel chamber may be extended upward substantially parallel to the cylinder head rather closer to the side of the cylinder head to which the fuel pump is mounted, and an upper end part may be disposed facing the upside of a cylinder head cover, and connected to the fuel pump by fuel piping raised from the upper end part and extending substantially parallel to the top face of the cylinder head cover.

According to this configuration, the fuel chamber and the fuel pipe are provided along the cylinder head, so that the fuel feeding device can be disposed in a compact manner.

Further, the injector may be disposed below an intake port and constructed to inject fuel directly to a combustion chamber.

In this case, the space in the center of the cylinder head can be secured by disposing the injector below the intake port, and it is possible to achieve the center plug system in which an ignition plug is provided in the central part of the cylinder head.

According to an embodiment of the present invention, the cylinder block of the V-shaped engine is disposed like a V-shape. Fuel is fed to an injector in a V-bank from a fuel pump, a fuel chamber is provided between the fuel pump and the injector, the fuel chamber is disposed lengthways in a vertical direction in the V-bank, a lower end part of the fuel chamber is disposed facing the side of the injector, and connected to the injector provided in each cylinder block by a fuel pipe branching from the lower end part and extending substantially horizontally, and a piping fitting surface is offset by projecting one fuel pipe fitting part of the fuel chamber over the other fuel pipe fitting part.

According to this configuration, one fitting part of the fuel pipe branching from the lower end part of the fuel chamber and extending horizontally in the V-bank is provided to offset from the other fuel pipe fitting part, and in fitting the fuel pipe to the fuel chamber, the positions of the pipe fitting surfaces are separate from each other, so that the mutual fitting parts do not cause any obstruction to the fitting work. Thus, even in a narrow space in the V-bank, the fuel pipe can be simply fitted to facilitate the fitting work for the fuel feeding device.

Further, in the above configuration, the offset amount of the piping fitting surface may be the same as the offset amount of an opposite cylinder.

In this case, since the offset amount of the piping fitting surface of the fuel chamber is the same as the offset amount of the cylinder, the distances from the respective piping fitting surfaces to the injectors of the respective cylinders can be made equal to each other, and the respective fuel pipes can be equal in length. Thus, the same fuel pipe can be used to decrease the number of kinds of parts.

Further, the fuel pump may be provided on one cylinder head, the fuel chamber may be extended upward substantially parallel to the cylinder head rather closer to the cylinder head on which the fuel pump is mounted, an upper end part may be disposed facing the upside of a cylinder head cover, and connected to the fuel pump mounted on the cylinder head by fuel piping raised from the upper end part and extending substantially parallel to the top face of the cylinder head cover.

In this case, since the fuel chamber and the fuel pipe are provided along the cylinder head, the fuel feeding device can be disposed in a compact manner.

Further, the injector may be disposed below an intake port and constructed to inject fuel directly to a combustion chamber.

In this case, the injector is disposed below the intake port, whereby the space in the center of the cylinder head can be secured to achieve a center plug system in which an ignition plug is provided in the central part of the cylinder head.

Effects of the invention include the following:

In the motorcycle in accordance with the invention, the fuel pump can be driven by the camshaft, also the fuel pump is provided on the front bank at the back of the head pipe and the fuel pump is disposed just at the back of the head pipe, so that the fuel pump can be covered with the head pipe and the frame in the vicinity of the head pipe and the fuel pump can be protected from the external force and the like without the special cover.

Further, since the fuel pump is disposed in a dead space at the back of the head pipe, it does not cause an obstruction to the disposition of the other parts. Further, the fuel pump is mounted in a position hard to see from the outside at the back of the head pipe and the fuel pump can be disposed not to be conspicuous, so that the appearance can be made clear-cut to improve the appearance of a vehicle.

Since the fuel pump is provided above the front camshaft of the front bank, the fuel pump can be disposed just at the back of the head pipe and the fuel pump can be protected from the external force or the like by the head pipe and the frame in the vicinity of the head pipe. Further, since the fuel pump can be driven by the camshaft in a close position to the head pipe, it is not necessary to lengthen a driving force transmission path between the camshaft and the fuel pump for disposing the fuel pump at the back of the head pipe.

Further, the fuel pump can be protected from the external force or the like by surrounding it using the head pipe and the main pipe and the down tube at the back of the head pipe.

The fuel piping is extended parallel along the top face of the cylinder head cover and disposed below the gusset pipe, and surrounded by the top face of the cylinder head cover and the gusset pipe, so that the fuel piping can be protected.

In the fuel feeding device of the V-shaped engine in accordance with the invention, the injector in the lower part in the V-bank and the fuel chamber can be connected to each other by the horizontal fuel pipe extended from the lower end part of the fuel chamber, and the fuel chamber is disposed lengthways in the vertical direction in the V-bank, so that a large space can be secured at the side of the fuel chamber in the V-bank. Thus, a tool or the like can be used utilizing the space in the V-bank, and the fuel pipe connecting the fuel chamber and the injector to each other can be assembled so that the injector can be disposed in the lower part in the V-bank.

Further, since the fuel pipe can be removed utilizing the space in the V-bank, the maintainability of the fuel feeding device including the injector can be improved.

The fuel chamber and the fuel piping are provided along the cylinder head, so that the fuel feeding device can be disposed in a compact manner.

Further, the center plug system can be achieved by disposing the injector below the intake port to secure the space in the center of the cylinder head.

In addition, one fitting part of the fuel pipe branching and extending horizontally in the V-bank is provided to offset from the other fuel pipe fitting part, so that the mutual fitting parts do not cause any obstruction to the fitting work. Thus, even in a narrow space in the V-bank, the fuel pipe can be simply fitted to facilitate the fitting work for the fuel feeding device.

Further, since the offset amount of the piping fitting surface is the same as the offset amount of the cylinder, the distances from the respective piping fitting surfaces to the injectors of the respective cylinders can be made equal to each other, and the respective fuel pipes can be equal in length. Thus, the same fuel pipe can be used to decrease the number of kinds of parts.

Further, since the fuel chamber and the fuel piping are provided along the cylinder head, the fuel feeding device can be disposed in a compact manner.

Further, the injector is disposed below the intake port, whereby the space in the center of the cylinder head can be secured to achieve a center plug system in which an ignition plug is provided in the central part of the cylinder head.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side view showing a motorcycle loaded with an engine according to an embodiment of the invention;

FIG. 2 is a side view showing the internal structure of the engine;

FIG. 3 is a side view showing an engine intake system and a fuel system of FIG. 2 to an enlarged scale;

FIG. 4 is a diagram showing the periphery of a camshaft to an enlarged scale;

FIG. 5 is a side view showing a valve gear;

FIG. 6 is a longitudinal section of the valve gear of a front bank as viewed from the rear side;

FIG. 7 is a longitudinal section of a driving mechanism as viewed from the side;

FIG. 8 is a longitudinal section of the driving mechanism, as viewed from the front side; and

FIG. 9 is a plan view of the periphery of the engine.

### DETAILED DESCRIPTION OF THE PREFERRED EMBODIMENTS

A preferred embodiment of the invention will now be described with reference to the attached drawings. In the description, the directions such as the front and back, the right and left and the up and down are mentioned with respect to a vehicle body.

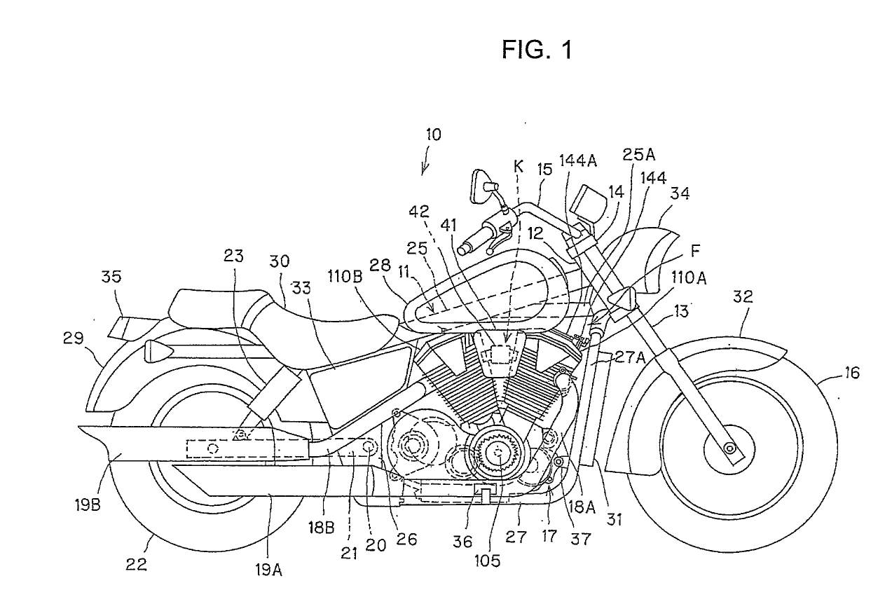

FIG. 1 is a side view showing a motorcycle to which an engine according to an embodiment of the invention is applied. The motorcycle 10 includes: a body frame 11; a pair of right and left front forks 13 rotatably supported on a head pipe 12 fitted to the front end of the vehicle body frame 11; a steering handlebar 15 fitted to a top bridge 14 supporting the upper ends of the front forks 13; a front wheel 16 rotatably supported on the front forks 13; an engine 17 as a V-shaped internal combustion engine supported on the vehicle body frame 11; exhaust mufflers 19A, 19B connected to the engine 17 through exhaust pipes 18A, 18B; a rear swing arm 21 supported to freely rock vertically on a pivot 21 at the lower side in the rear of the vehicle body frame 11; and a rear wheel 22 rotatably supported on the rear end part of the rear swing arm 21, wherein a rear cushion 23 is disposed between the rear swing arm 21 and the vehicle body frame 11.

The vehicle body frame 11 includes: a main frame 25 extending from the head pipe 12 to descend backward; a pair of right and left pivot plates (called a center frame as well) 26 connected to the rear part of the main frame 25; and a down tube 27 extending downward from the head pipe 12, and then bent to extend and connected to the pivot plates 26. A fuel tank 28 is supported to stride over the main frame 25, the rear of the main frame 25 is extended above the rear wheel 22 to support a rear fender 29, and a seat 30 is supported between the upside of the rear fender 29 and the fuel tank 28. In FIG. 1, the reference numeral 31 is a radiator supported on the down tube 27, the reference numeral 32 is a front fender, 33 is a side cover, 34 is a headlight, 35 is a taillight, and 36 is a rider step.

The engine 17 is supported in a space surrounded by the main frame 25, the pivot plates 26 and the down tube 27. The engine 17 is a longitudinally V-shaped two-cylinder water cooled 4-cycle engine in which a cylinder is longitudinally banked V-shaped. The engine 17 is supported on the vehicle body frame 11 through a plurality of engine brackets 37 (only partially illustrated in FIG. 1) so that a crankshaft 105 directs right and left horizontally with respect to the vehicle body. The power of the engine 17 is transmitted to the rear wheel 22 through a drive shaft (not shown) disposed on the left of the rear wheel 22.

The engine 17 is formed so that a contained angle (called a bank angle as well) formed by a front bank 110A (a cylinder block) and a rear bank 110B (a cylinder block) respectively constituting a cylinder is smaller (e.g. 52 degrees) than 90 degrees. The valve gears of the respective banks 110A, 110B are both constituted by a 4-valve double overhead camshaft (DOHC) system.

An air cleaner 41 and a throttle body 42 constituting an engine intake system and an injector 143 for feeding fuel to the engine 17 are disposed in a V-bank space K (V bank), which is a space formed like a V-shape in a side view between the front bank 110A and the rear bank 110B. The throttle body 42 supplies the air purged by the air cleaner 41 to the front bank 110A and the rear bank 110B. The exhaust pipes 18A, 18B constituting an engine exhaust system are connected to the respective banks 110A, 110B, the respective exhaust pipes 18A, 18B are passed through the right side of the vehicle body, and the exhaust mufflers 19A, 19B are respectively connected to the rear ends thereof. The exhaust gas is discharged through these exhaust pipes 18A, 18B and exhaust mufflers 19A, 19B.

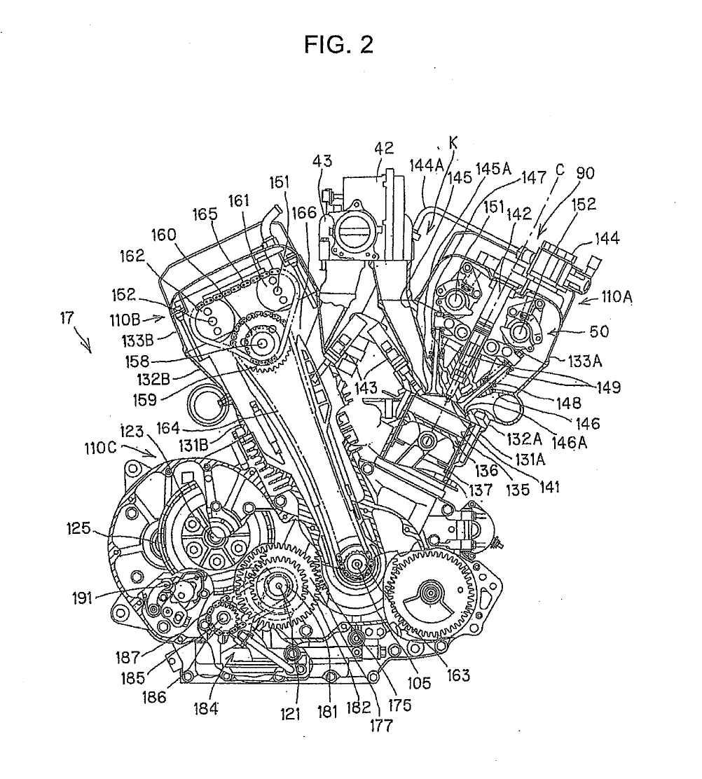

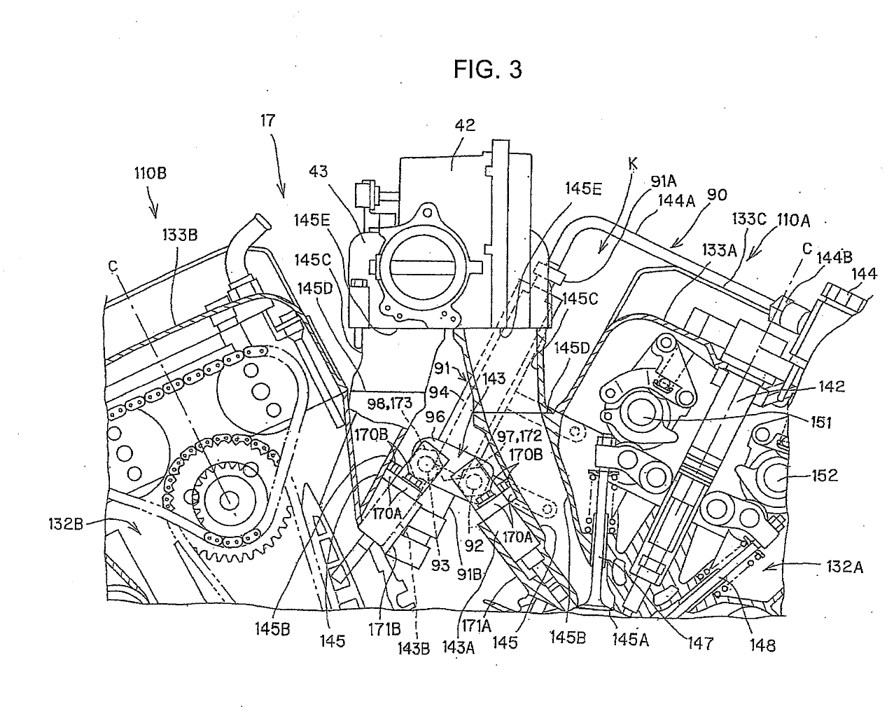

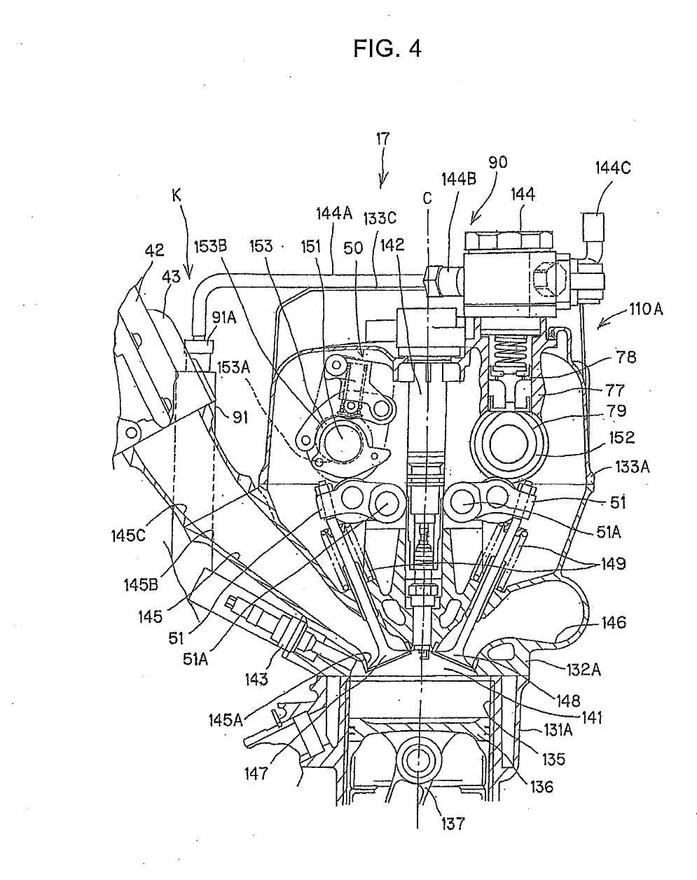

FIG. 2 is a diagram of an internal structure of the engine 17 as viewed from the side, FIG. 3 is a side view showing the engine intake system and the fuel system of FIG. 2 to an enlarged scale, and FIG. 4 is a diagram showing the internal structure of the front bank 110A of FIG. 2 to an enlarged scale.

In FIG. 2, the front bank 110A and the rear bank 110B of the engine 17 have the same structure. In FIG. 2, the front bank 110A shows the periphery of a piston and the rear bank 110B shows the periphery of a cam chain. In FIG. 2, the reference numeral 121 designates an intermediate shaft (a rear balancer shaft), 123 a main shaft, and 125 a countershaft. These shafts 121, 123, 125 including the crankshaft 105 are disposed parallel to each other to shift from each other in the longitudinal direction and vertical direction of the vehicle body, and in a crankcase 110C supporting the shafts, a gear transmission mechanism is constructed to transmit the rotation of the crankshaft 105 to the intermediate shaft 121, the main shaft 123 and the countershaft 125 in order.

As shown in FIG. 2, a front cylinder block 131A and a rear cylinder block 131B are disposed on the top face of the crankcase 110C of the engine 17 to form a predetermined contained angle between them at the front part and at the back part of the vehicle body, a front cylinder head 132A and a rear cylinder head 132B are respectively coupled to the top faces of the cylinder blocks 131A, 131B, and further head covers 133A, 133B (cylinder head covers) are respectively mounted on the top faces of the respective cylinder heads 132A, 132B to thereby constitute the front bank 110A and the rear back 110B.

A cylinder bore 135 is formed in each of the cylinder blocks 131A, 131B, a piston 136 is slidably inserted in each of the cylinder bores 135, and the respective pistons 136 are connected to the crankshaft 105 through a connecting rod 137.

The lower surfaces of the cylinder heads 132A, 132B are respectively provided with combustion recessed parts 141 constituting the top face of a combustion chamber formed above the piston 136, and an ignition plug 142 is disposed with the tip facing each combustion recessed part 141. The ignition plug 142 is provided substantially coaxial with the cylinder axis C.

The engine 17 is a cylinder injection engine, which injects fuel from the injectors 143 provided in the respective combustion recessed parts 141 directly into the combustion recessed parts 141. The respective injectors 143 are inserted from the inner side surfaces of the V-bank space K of the respective cylinder heads 132A, 132B, and disposed with the tips thereof facing the combustion recessed parts 141.

A fuel pump 144 is provided above the cylinder head 132A, and fuel is supplied from the fuel pump 144 through fuel piping 144A to the respective injectors 143.

An intake port 145 communicated to the respective combustion recessed parts 141 at a pair of opening parts 145A and an exhaust port 146 communicated to the respective recessed parts 141 at a pair of opening parts 146A are formed on the respective cylinder heads 132A, 132B. The intake port 145 is disposed between the cylinder axis C and the injector 143.

As shown in FIG. 2 and FIG. 3, the intake ports 145 join each other in an intake chamber 43, and the intake chamber 43 is connected to the throttle body 42. A TBW (a throttle by wire), which changes the sectional area of a throttle valve by the drive of an actuator, is adopted for the throttle body 42. The exhaust port 146 of the cylinder head 132A is connected to the exhaust pipe 18A (See FIG. 1), and the exhaust port 146 of the cylinder head 132B is connected to the exhaust pipe 18B (See FIG. 1).

As shown in FIG. 2, a pair of intake valves 147 opening and closing the opening part 145A of the intake port 145 and a pair of exhaust valves 148 opening and closing the opening part 146A of the intake port 146 are disposed in the cylinder heads 132A, 132B. The intake valves 147 and the exhaust valves 148 are respectively energized in the directions of closing the respective ports by valve springs 149, 149.

The respective valve elements 147, 148 are driven by valve gears 50 capable of changing the valve operating characteristics such as the timing of opening and closing and the lift. The valve gears 50 include intake side and exhaust side camshafts 151, 152, which are rotatably supported on the cylinder heads 132A, 132B and rotated in synchronization with the rotation of the engine 17.

As shown in FIG. 2, an intermediate shaft 158 is rotatably supported on each one end side in width direction of the cylinder heads 132A, 132B, and intermediate sprockets 159, 160 are fixed to the intermediate shaft 158. A driven sprocket 161 is fixed to one end side of the camshaft 151, a driven sprocket 162 is fixed to one end side of the camshaft 152, and a driving sprocket 163 is fixed to both end sides of the crankshaft 105. A first cam chain 164 is wrapped round these sprockets 159, 163, and a second cam chain 165 is wrapped round the sprockets 160 to 162. The sprockets 159 to 163 and the cam chains 164, 165 are housed in a cam chain chamber 166 formed at one end side of each bank 110A, 110B.

The reduction gear ratio from the driving sprocket 163 to the driven sprockets 161, 162 is set to 2, and when the crankshaft 105 is rotated, the driving sprocket 163 is rotated in a body with the crankshaft 105, the driven sprockets 161, 162 are rotated through the cam chains 164, 165 at half the rotating speed of the crankshaft 105, and the intake valve 147 and the exhaust valve 148 open and close the intake port 145 and the exhaust port 146, respectively, according to the cam profiles of the camshafts 151, 152 rotated in a body with the driven sprockets 161, 162.

A generator not shown is provided at the left end of the crankshaft 105, and at the right end of the crankshaft 105, a driving gear (hereinafter referred to as a crank side driving gear) 175 is fixed to the inside (the left side of the vehicle body) of the above right driving sprocket 163. The crank side driving gear 175 meshes with a driven gear (hereinafter referred to as an intermediate side driven gear) 177 provided on the intermediate shaft 121 to transmit the rotation of the crankshaft 105 to the intermediate shaft 121 at a constant velocity, thereby rotating the intermediate shaft 121 at the same speed as the crankshaft 105 in the reverse direction.

The intermediate shaft 121 is rotatably supported below the rear side of the crankshaft 105 and also below the front side of the main shaft 123.

A driving sprocket 181 for the oil pump, the above intermediate side driven gear 177 and a driving gear (hereinafter referred to as an intermediate side driving bear) 182 having a smaller diameter than the driven gear 177 are mounted in order at the right end of the intermediate shaft 121.

The driving sprocket 181 for an oil pump transmits the turning force of the intermediate shaft 121 through a transmission chain 187 to a driven sprocket 186 fixed to a driving shaft 185 of the oil pump 184 disposed at the back of the intermediate shaft 121 and below the main shaft 123 to thereby drive the oil pump 184.

The intermediate side driving gear 182 meshes with a driven gear (hereinafter referred to as a main side driven gear) 191 provided on the main shaft 123 to freely rotate relatively to thereby reduce the speed of the rotation of the intermediate shaft 121 and transmit the same to the main shaft 123 through a clutch mechanism (not shown). That is, the reduction gear ratio from the crankshaft 105 to the main shaft 123, that is, the primary reduction gear ratio of the engine 17 is set by the reduction gear ratio of the intermediate side driving gear 182 and the main side driven gear 191.

The main shaft 123 is rotatably supported above the rear of the crankshaft 105, and the counter shaft 125 is rotatably supported substantially at the back of the main shaft 123. A transmission gear group not shown is disposed to stretch between the main shaft 123 and the countershaft 125, thereby constituting a transmission.

The left end of the countershaft 125 is connected to a drive shaft (not shown) extending in the longitudinal direction of the vehicle body. Thus, the rotation of the countershaft 125 is transmitted to the drive shaft.

FIG. 4 is a diagram showing the periphery of the camshafts 151, 152 to an enlarged scale.

In the drawing, the camshaft 151 side shows a valve train, and the camshaft 152 side mainly shows a driving system of the fuel pump 144.

An intake cam 153 is, as shown in FIG. 4, formed integral with the camshaft 151. The intake cam 153 includes a base circular part 153A forming a circular cam face and a cam angled part 153B, which is projected from the base circular part 153A to the outer peripheral side to form an angled cam face. An exhaust cam 154 is formed integral with the camshaft 152. The exhaust cam 154 includes a base circular part 154A forming a circular cam face and a cam angled part 154B, which is projected from the base circular part 154A to the outer peripheral side to form an angled cam face.

On the camshaft 152 side, the fuel feeding device 90 including the fuel pump 144 is connected to a driving system provided on the camshaft 152 to drive the fuel pump 144.

The fuel pump 144 is provided on the head cover 133A of the cylinder head 132A and driven by the camshaft 152. To be specific, the fuel pump 144 is a plunger pump including a plunger housing part 77 provided on the head cover 133A and a plunger 78 reciprocating up and down in the plunger housing part 77, and driven by a pump driving cam 79 provided on the camshaft 152 to reciprocate the plunger 78 up and down.

That is, when the plunger 78 is reciprocated up and down by the pump driving cam 79 rotated in a body with the camshaft 152 and the space in the interior of the fuel pump 144 is alternately expanded and contracted by the vertical motion of the plunger 78, the fuel pump 144 alternately sucks and discharges fuel to continuously supply the fuel sucked from the fuel tank 28 (See FIG. 1) to the engine 17.

As the fuel pump 144 is driven by the exhaust side camshaft 152 provided on the vehicle front side between two camshafts of the cylinder head 132A, the fuel pump 144 is located right above the camshaft 152 and disposed on the front in the upper part of the cylinder head 132A. Further, the fuel pump 144 is located inside the width of the cylinder head 132A in the vehicle width direction not to project from the top face of the cylinder head 132A in the width direction.

The fuel pump 144 is mounted with the upper part projected outward from the head cover 133A, the back thereof is provided with a fuel piping connecting part 144B to which the fuel piping 144A is connected, and the front thereof is provided with a tank piping connecting part 144C to which a pipe (not shown) from the fuel tank 28 is connected.

The fuel pump 144 is, as shown in FIG. 1, disposed in a front space F surrounded by the vehicle body frame 11 at the back of the head pipe 12. To be precise, the vehicle body frame 11 of the front of the vehicle includes: the head pipe 12; the one main frame 25 extending from the vertical intermediate part of the head pipe 12 to descend backward; the one gusset pipe 25A extending from the lower part of the head pipe 12 backward substantially horizontally and connected to the intermediate part of the main frame 25; and a down pipe 27A extending downward from the lower part of the head pipe 12. The down pipe 27A is formed of a pair of right and left ones, which are bent right and left from the lower part of the head pipe 12 to expand in the vehicle width direction, and then extended downward substantially parallel to each other. The space between the right and left down pipes 27A is substantially equal to the length in the width direction of the engine 17, and the right and left down pipes 27A respectively pass in front of the engine 17. The down pipes 27A are parts of the down tube 27.

The front space F is the space whose periphery is surrounded by the main frame 25, the gusset pipe 25A, the head pipe 12, the down pipe 27A and the upper part of the front bank 110A, and the fuel pump 144 is disposed in the front space F. That is, since the fuel pump 144 is provided in a position surrounded by the main frame 25, the gusset pipe 25A, the head pipe 12, the down pipe 27A and the upper part of the front bank 110A, when the external force or the like is applied to the front of the vehicle, the fuel pump 144 can be protected from disturbance such as the external force.

The front space F at the back of the head pipe 12 is a dead space where some other parts are not disposed, and since the fuel pump 144 is provided utilizing the dead space, the fuel pump 144 can be disposed without causing any obstruction to the other parts.

The respective intake ports 145, as shown in FIG. 3, include lower intake ports 145B provided integral with the cylinder heads 132A, 132B and upper intake ports 145C separate from the cylinder heads 132A, 132B and connected to the upper ends 145D of the lower intake ports 145B. The upper intake ports 145C are fixed to the lower intake ports 145B by bolts not shown, and extended with the angles varied in the direction of approaching the head covers 133A, 133B. The injectors 143 are provided along the lower intake ports 145B below the lower intake ports 145B.

The upper intake ports 145C of the banks 110A, 110B are extended upward substantially parallel to each other, and the intake chamber 43 disposed in the V-bank space K is connected to the upper ends 145E of the respective upper intake ports 145C. The intake chamber 43 functions as a repress tank for restraining intake pulsation by providing an intake passage between the intake port 145 and the throttle body 42 with a larger capacity than the intake passages of the intake port 145 and the throttle body 42.

Since the intake ports 145 include the lower intake ports 145B provided integral with the cylinder heads 132A, 132B and the upper intake ports 145C provided separate from the cylinder heads 132A, 132B, the upper intake ports 145C can be detached from the cylinder heads 132A, 132B, and the work for attaching and detaching the injector 143 can be performed utilizing the space secured by detaching the upper intake ports 145C. As a result, even if the bank angle is small, the injectors 143 can be provided in the V-bank space K. Further, since the upper intake ports 145C are fitted, with the angle varied in the direction of approaching the head covers 133A, 133B, the space between the banks can be enlarged to facilitate the work for attaching and detaching the upper intake ports 145C.

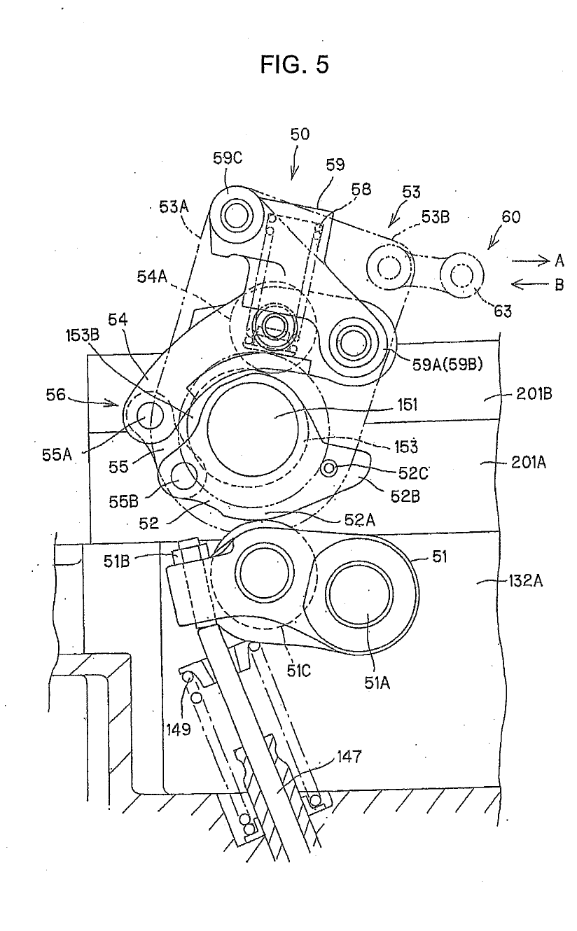

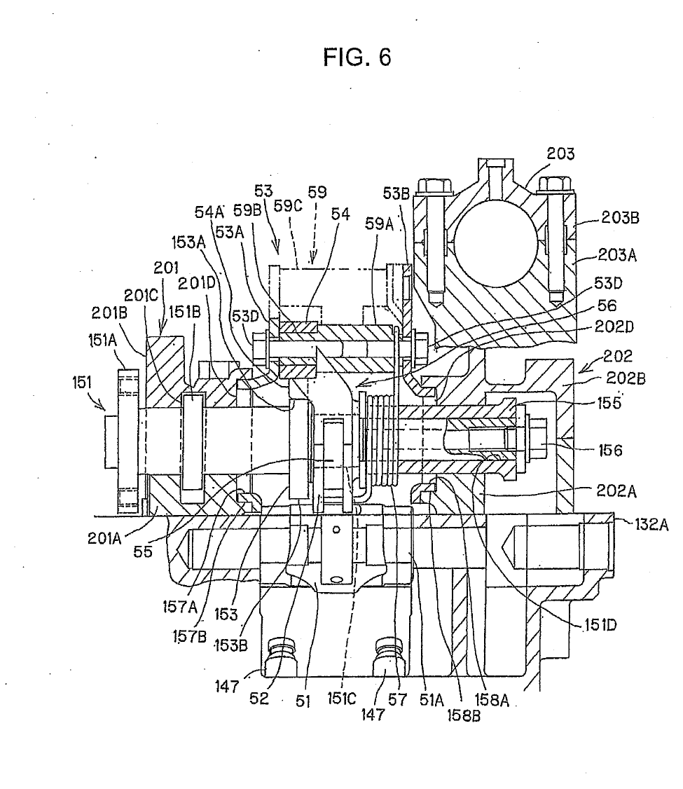

FIG. 5 is a side view showing the valve gear 50, and FIG. 6 is a longitudinal sectional view of the valve gear 50 of the front bank 110A, taken from the rear side.

The valve gears 50 are, as shown in FIG. 3, independently provided on the intake side and the exhaust side symmetrically about the cylinder axis C. Since the valve gears 50 of the front bank 110A and the rear bank 110B have the substantially same structure, the valve gear on the intake side of the front bank 110A will be described in the present embodiment.

The valve gear 50, as shown in FIG. 5 and FIG. 6, includes: a camshaft 151 (a camshaft 152 on the exhaust side); an intake cam 153 (an exhaust cam 154 on the exhaust side) rotated in a body with the camshaft 151; a rocker arm 51 for opening and closing an intake valve 147 (an exhaust valve 148 on the exhaust side); a valve cam 52 relatively rotatably supported by the camshaft 151 and opening and closing the intake valve 147 through the rocker arm 51; a holder 53 freely rockable around the camshaft 151; a link mechanism 56 rockably supported on the holder 53 to transmit the valve driving force of the intake cam 153 to the valve cam 52, thereby rocking the valve cam 52; and a driving mechanism 60 for rocking the holder 53. Further, the link mechanism 56 includes a sub-rocker arm 54 connected to the holder 53 and a connect link 55 rockably connecting the sub-rocker arm 54 and the valve cam 52.

The rocker arm 51 is formed wider, and a pair of intake valves 147 is opened and closed by one rocker arm 51. The rocker arm 51 is rockably supported at one end on a rocker arm pivot 51A fixed to the cylinder head 132A. The other end of the rocker arm 51 is provided with a pair of adjusting screws 51B abutting on the upper ends of the respective intake valves 147, and a roller 51C coming into contact with the valve cam 52 is rotatably supported on the central part.

As shown in FIG. 6, the camshaft 151 includes a sprocket fixing part 151A where the driven sprocket 161 (See FIG. 2) is fixed at one end side, wherein a positioning part 151B projected to the outer periphery of the camshaft 151 and having a circular sectional form, the intake cam 153, a rocking cam support part 151C rockably supporting the valve cam 52, and a collar fitting part 151D formed with a smaller diameter than the rocking cam support part 151C are provided in order from the sprocket fixing part 151A side. A camshaft collar 155 functioning as a bearing of the camshaft 151 is fitted to the collar fitting part 151D, and the camshaft collar 155 is pressed to the valve cam 52 side by a fixing bolt 156 fastened in to the other end of the camshaft 151.

The camshaft 151 is rotatably supported at both ends thereof by the camshaft support parts 201, 202. To be precise, the camshaft support parts 201, 202 are constructed by fixing caps 201B, 202B having support parts semi-circular in section to the head side support parts 201A, 202A, respectively, which are formed on the upside of the cylinder head 132A. A groove 201C formed according to the shape of the positioning part 151B is formed in the camshaft support part 201 provided on the positioning part 151B side, and the position of the positioning part 151B is regulated by the groove 201C to thereby position the camshaft 151 in the axial direction.

The faces on the side of the intake cam 153 in the camshaft support parts 201, 202 are respectively provided with holder support parts 201D, 202D supporting the holder 53.

The valve cam 52 is disposed in the rocking cam support part 151C provided on the intermediate part of the camshaft 151. As shown in FIG. 5, a base circular part 52A for keeping the intake valve 147 in the valve closed state and a cam angled part 52B for pushing down the intake valve 147 to be opened are formed on the valve cam 52, and a through hole 52C is formed in the cam angled part 52B. One end of a valve cam return spring 57 (See FIG. 6) for energizing the valve cam 52 in the direction of the cam angled part 52B separating from the roller 51C of the rocker arm 51, that is, in the direction of closing the intake valve 147, is fitted to the through hole 52C. The valve cam return spring 57 is, as shown in FIG. 6, wrapped round the camshaft 151, and the other end is fitted to the holder 53.

The holder 53 includes: first and second plates 53A, 53B disposed at a predetermined space in the axial direction of the camshaft 151 with the intake cam 153 and the valve cam 52 sandwiched between them; and a connecting member 59 connecting the first and second plates 53A, 53B in the axial direction of the camshaft 151. The first plate 53A is disposed at one end side to which the driven sprocket 161 of the camshaft 151 is fixed, and the second plate 53B is disposed at the other end of the camshaft 151.

The connecting member 59 has a shaft part 59A parallel to the camshaft 151, and a sub-rocker arm support part 59B to which one end of the sub-rocker arm 54 is connected is formed at the end on the first plate 53A side of the shaft part 59A. The connecting member 59 is fixed to the first and second plates 53A, 53B by a pair of bolts 53D inserted into both ends of the shaft part 59A from the outer surface sides of the first and second plates 53A, 53B. Further, the connecting member 59 is provided with a shaft part 59C parallel to the shaft part 59A, and fixed to the first and second plates 53A, 53B by a pair of bolts (not shown) as well, which are inserted into both ends of the shaft part 59C from the outer surface sides of the first and second plates 53A, 53B.

Further, the first and second plates 53A, 53B respectively have shaft holes 157A, 158A through which the camshaft 151 penetrates, and the peripheral edge parts of the shaft holes 157A, 158A are annular projecting parts 157B, 158B projected toward holder support parts 201D, 202D. The holder 53 is supported by fitting the projecting parts 157B, 158B to the holder support parts 201D, 202D, and rockable about the camshaft 151.

The sub-rocker arm 54 is disposed together with the intake cam 153 and the valve cam 52 between the first and second plates 53A, 53B, rotatably supported on the sub-rocker arm support part 59B of the connecting member 59 at one end part to rock about the sub-rocker arm support part 59B. A roller 54A coming into contact with the intake cam 153 is rotatably supported on the central part of the sub-rocker arm 54. One end of the connect link 55 is connected to the other end part of the sub-rocker arm 54 through a pin 55A (See FIG. 5) rockably supporting the connect link 55, and the valve cam 52 is connected to the other end of the connect link 55 through a pin 55B (See FIG. 5) rockably supporting the valve cam 52.

The sub-rocker arm 54 is, as shown in FIG. 5, energized by a sub-rocker arm return spring 58 housed in the connecting member 59, and the roller 54A of the sub-rocker arm 54 is always pressed to the intake cam 153. In this case, the sub-rocker arm return spring 58 is a coiled spring.

The operation will now be described.

In the thus constructed valve system 50, with reference to FIG. 5, when the camshaft 151 is rotated, the sub-rocker arm 54 is pushed up through the roller 54A by the cam angled part 153B of the intake cam 153 rotated in a body with the camshaft 151 and rocked around the shaft part 59A, and with this rocking, the valve cam 52 is rotated clockwise in FIG. 5 around the camshaft 151 through the connect link 55. The cam angled part 52B is caused to push down the intake valve 147 together with the rocker arm 51 through the roller 51C by the rotation of the valve cam 52, thereby opening the intake valve 147. The camshaft 151 is further rotated so that with the base circular part 153A of the intake cam 153 abutting on the roller 54A, the sub-rocker arm 54 is pushed down by the sub-rocker arm return spring 58, and also the valve cam 52 is rotated counter clockwise in FIG. 5 by the valve cam return spring 57 to bring the base circular part 52A into contact with the roller 51C. Thus, the intake valve 147 is pushed up by a valve spring 149 (See FIG. 2) and opened.

In this valve gear 50, as shown in FIG. 5, a connecting link member 63 is connected to the holder 53. When the connecting link member 63 is moved in the direction of an arrow A, the holder 53 rocks clockwise around the axis of the intake side camshaft 151 and the sub-rocker arm support part 59B displaces downward in the drawing, and when being moved in the direction of an arrow B, the holder 53 rocks counter clockwise around the axis of the intake side dam shaft 151 and the sub-rocker arm support part 59B displaces upward in the drawing.

Thus, the valve gear 50 is configured to change the opening and closing operation characteristic of the intake valve 147 and the exhaust valve 148.

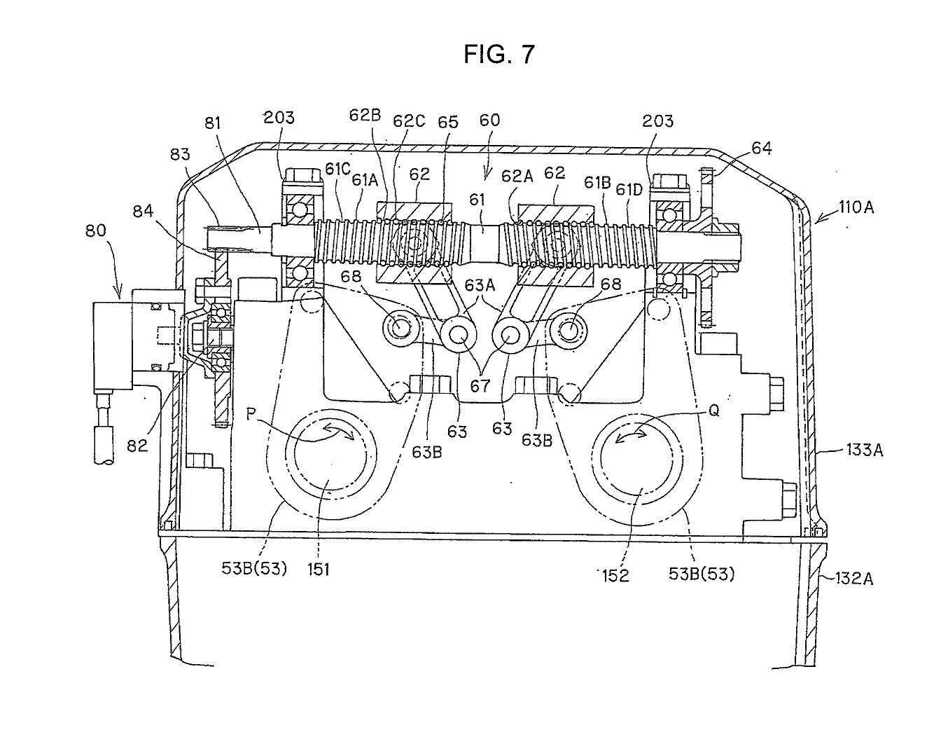

The connecting link member 63 is, as shown in FIG. 7, connected to the driving mechanism 60.

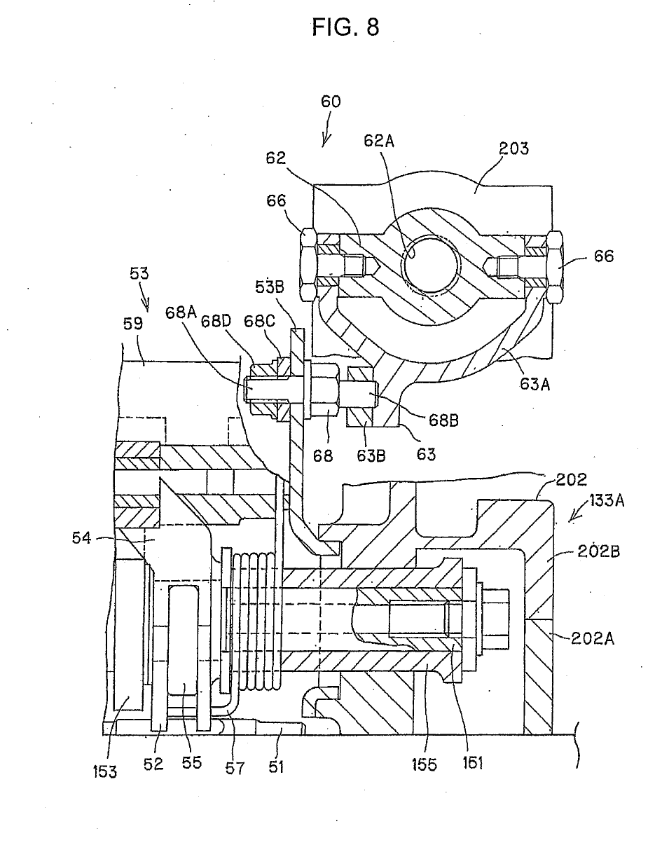

FIG. 7 is a longitudinal section of the driving mechanism 60, as viewed from the side thereof; and FIG. 8 is a longitudinal section of the driving mechanism 60, as viewed from the front thereof.

The driving mechanism 60 is, as shown in FIG. 7, connected to the holder 53 through the connecting link member 63. The driving mechanism 60 includes a ball screw 61 disposed to extend over the intake side camshaft 151 and the exhaust side camshaft 152 and two nuts 62 provided on the intake side and the exhaust side, respectively and movable in the axial direction on the ball screw 61, wherein the connecting link member 63 is disposed between the nut 62 and the holder 53.

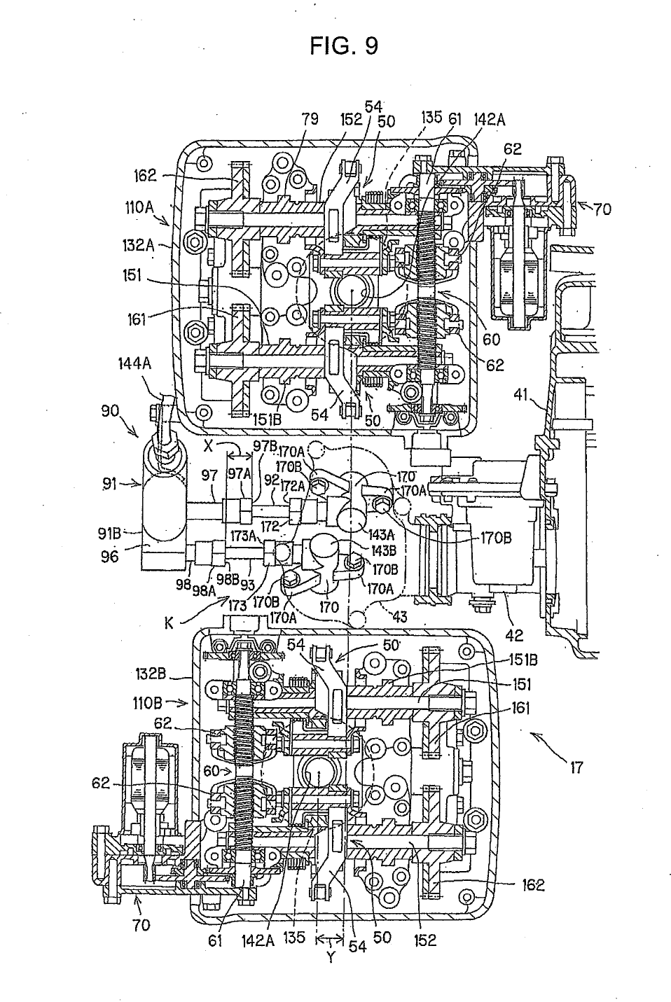

A gear 64 is fixed to one end at the exhaust side of the ball screw 61, and a motor-driven actuator 70 (See FIG. 9) for rotating the ball screw 61 is connected to the gear 64 by a gear train.

The ball screw 61 is orthogonal to the camshafts 151, 152, and disposed on the other end sides of these camshafts 151, 152, that is, on the opposite side to the driven sprockets 161, 162 (See FIG. 2) fixed side. Thus, the ball screw 61 is not extended in the vertical direction of the engine 17, but disposed to extend over the intake side camshaft 151 and the exhaust side camshaft 152, so that the height of the engine 17 can be lowered. The ball screw 61 is rotatably supported at both ends thereof by ball screw support parts 203, respectively. The ball screw support parts 203 are, as shown in FIG. 6, respectively constructed by fixing a cap 203B having a support part semi-circular in section to the camshaft side support part 203A formed on the upside of a camshaft support part 202.

As shown in FIG. 7, spiral screw threads 61A, 61B and spiral axial thread grooves 61C, 61D on the intake side and on the exhaust side, respectively are formed on the outer peripheral surface of the ball screw 61. These screw threads 61A, 61B and the axial thread grooves 61C, 61D are set to be different in winding direction between the intake side and the exhaust side.

The other end at the intake side of the ball screw 61 is provided with a sensor 80 for detecting the rotation of the ball screw 61. The sensor 80 is fixed to the sidewall part located in the V-bank space K of the head cover 133A (133B). The sensor 80 is thus disposed in the V-bank space K, so that the length of the engine 17 in the longitudinal direction of the vehicle body can be shortened and the periphery of the sensor 80 can be surrounded by the front bank 110A and the rear bank 110B (See FIG. 2).

The sensor 80 includes a rotating shaft 81 fixed to the other end of the ball screw 61 and a fixed shaft 82, which is disposed below the rotating shaft 81 substantially parallel and formed of a hexagonal screw fixed to the ball screw support part 203. A driving gear 83 is formed on the outer peripheral surface of the rotating shaft 81, and a driven gear 84 meshing with the driving gear 83 is formed on the fixed shaft 82. Therefore, when the ball screw 61 is rotated, the rotation of the rotating shaft 81 rotated in a body with the ball screw 61 is transmitted through the driving gear 83 to the driven gear 84. The sensor 80 detects the rotation amount of the ball screw 61 according to the rotation amount of the driven gear 84.

The nut 62 has a through hole 62A where the ball screw 61 penetrates, and the inner peripheral surface of the through hole 62A is provided with a spiral nut screw thread 62B formed corresponding to the screw threads 61A, 61B and a spiral nut screw thread 62C formed corresponding to the screw threads 61C, 61D. A plurality of balls 65 capable of rolling are disposed between the nut screw thread 62C and the screw threads 61C, 61D. The nut 62 is moved on the ball screw 61 through the balls 65 by rotating the ball screw 61.

The connecting link member 63, as shown in FIG. 7 and FIG. 8, includes a nut side link 63A whose one end is fixed to the nut 62 and a holder side link 63B connecting the other end of the nut side link 63A and the second plate 53B to each other.

One end of the nut side link 63A holds the nut 62 from both sides, and is fixed to the nut 62 by bolts 66. The other end of the nut side link 63A is rockably supported on one end of the holder side link 63B by pins 67. The other end of the holder side link 63B is rockably supported on the second plate 53B by an eccentric pin 68. The eccentric pin 68 includes a hexagonal bolt 68A and an eccentric shaft 68B integrally formed on the head of the hexagonal bolt 68A with eccentricity. The hexagonal bolt 68A is fixed to the second plate 53B by a spring washer 68C and the hexagonal nut 68D, and the eccentric shaft 68B is rotatably supported on the nut side link 63A.

In FIG. 7, when the holders 53 rock in the directions of arrows P, Q, the position of the sub-rocker arm 59B of the link mechanism 56 shown in FIG. 5 is changed. By the change in position of the sub-rocker arm support part 59B, the valve cam 52 is rocked around the camshaft 151 and displaced in the circumferential direction with respect to the camshaft 151 so that the circumferential phase to the intake cam 153, the angle position or the circumferential position in this case is changed. Thus, by the change in the circumferential position of the valve cam 52 with respect to the intake cam 153, the period of time when the cam angled part 52B of the valve cam 52 abuts on the roller 51C and the push-down amount can be changed, so that the valve opening period of the intake valve and the lift of the intake valve 147 can be changed.

When the ball screw 61 is rotated to move the nut 62 to the center side of the ball screw 61 and the holder 53 is further rocked clockwise in FIG. 5 by the connecting link member 63, for example, the valve cam 52 is rotated clockwise by the link mechanism 56, and when the camshaft 151 is rotated in this state, the push-down period and the push-down amount of the cam angled part 53B to the roller 51C are increased to increase the valve opening period and lift of the intake valve 147.

The fuel feeding device 90 will now be described.

As shown in FIG. 3, the fuel feeding device 90 includes: the fuel pump 144; the fuel piping 144A; a fuel chamber 91 connected to the downstream end of the fuel piping 144A; fuel pipes 92, 93 connecting the fuel chamber 91 and an injector 143; and the injector 143.

The fuel chamber 91, the fuel pipes 92, 93 and the injector 143 are provided in the V-bank space K between the front bank 110A and the rear bank 110B.

The fuel chamber 91 is a cylindrical longitudinal cylinder, which is disposed lengthways in the vertical direction in the V-bank space K. The fuel chamber 91 is mounted between the fuel pump 144 and the injector 143 in a fuel passage.

The fuel chamber 91 has an accumulator 94 for storing high-pressure fuel pressurized by the fuel pump 144, and the fuel chamber 91 is formed with such dimensions enough to relax fluctuation of fuel pressure in the fuel chamber 91 due to fuel injection of the injector 143 by the accumulator 94.

The fuel chamber 91 is mounted with the axis of the cylinder tilted forward at the substantially same angle as the cylinder axis C of the cylinder head 132A, the upper end part 91A to which the fuel piping 144A is connected is located on the upside of the V-bank space K, and the lower end part 91B to which the fuel pipes 92, 93 are connected is located at the equal height to the injector 143 in the V-bank space K.

That is, the fuel chamber 91 is extended upward substantially parallel to the cylinder head 132A near the side of the cylinder head 132A, and the upper end part 91A is disposed facing the upside of the head cover 133A. The fuel piping 144A is raised from the upper end part 91A, bent forward substantially at right angles, and extended substantially parallel to the top face 133C of the head cover 133A to be connected to the fuel piping connecting part 144B of the fuel pump 144. Since the fuel chamber 91 and the fuel piping 144A are thus mounted along the cylinder head 132A, the fuel feeding device 90 can be disposed in a compact manner.

Further, the fuel piping 144A is disposed between the top face 133C and the gusset pipe 25A (See FIG. 1) and surrounded from above and below by the top face 133C and the gusset pipe 25A, so that the fuel piping 144A can be protected from the external force or the like.

FIG. 9 is a plan view of the periphery of the engine 17.

As shown in FIG. 3 and FIG. 9, the fuel chamber 91 is mounted on the left end side opposite to the air cleaner 41 and disposed lengthways in the V-bank space K, and the fuel chamber 91 is mounted to occupy the V-bank space K in a low proportion. Thus, a large space can be secured in the V-bank space K on the right of the fuel chamber 91 to improve the degree of freedom in arranging the components such as the throttle body 42, the intake chamber 43, the intake port 145, and the injector 143.

The lower end part 91B of the fuel chamber 91 is provided with a branch part 96 communicated to the accumulator 94 and projected in the longitudinal direction. The face pointing toward the V-bank space K in the branch part is provided with a front fitting part 97 to which the fuel pipe 92 is connected and a rear fitting part 98 to which the fuel pipe 93 is connected, and the fuel in the accumulator 94 branches at the branching part 96 to flow downstream. In this case, the fuel pipe 92 is a pipe connected to the injector 143A fitted to the cylinder head 132A, and the fuel pipe 93 is a pipe connected to the injector 143B fitted to the cylinder head 132B.

The front fitting part 97 and the rear fitting part 98 are formed like pipes projected toward the injectors 143A, 143B, and the respective ends thereof are provided with fitting nut parts 97A, 98A. The front fitting part 97 and the rear fitting part 98 are spaced from each other in the longitudinal direction of the vehicle, and extended substantially horizontally and parallel to each other. The fuel pipes 92, 93 are easily attached and detached by rotating the fitting nut parts 97A, 98A using a tool or the like in the state of being inserted in the fitting nut parts 97A, 98A.

At the end faces on the sides of the injectors 143A, 143B in the fitting nut parts 97A, 98A, piping fitting surfaces 97B, 98B where the fuel pipes 92, 93 are respectively inserted are located, the piping fitting surface 97B to which the fuel pipe 92 is connected is projected toward the injector 143 more than the piping fitting surface 98B to which the fuel pipe 93 is connected. That is, the piping fitting surface 97B is offset toward the injector 143 more than the piping fitting surface 98B. In this case, the offset amount of the piping fitting surface 97B from the pipe fitting surface 98B is indicated by an offset amount X in FIG. 9.

In the engine 17, two connecting rods 137 (See FIG. 2) connected to each piston 136 are connected side by side to the same crank pin (not shown) of the crankshaft 105 in the axial direction of the crankshaft 105. Therefore, as shown in FIG. 9, the cylinder bore 135 of the front cylinder block 131A and the cylinder bore 135 of the rear cylinder block 131B are disposed with an offset in the axial direction of the crankshaft 105 only for the thickness of a larger end part of the connecting rod 137 coupled to the crank pin, and the cylinder bore 135 of the front cylinder block 131A is disposed to shift toward the air cleaner 41 by an offset amount Y. With this configuration, the injectors 143A, 143B are offset from each other together with the cylinder bores 135, and disposed to shift in the axial direction of the crankshaft 105, and the injector 143A is disposed to shift toward the air cleaner 41 more than the injector 143B by the offset amount Y.

The injectors 143A, 143B are located at the intermediate part in the width direction in the V-bank space K below the intake chamber 43, and respectively mounted at the same position as a plug hole 142A provided with the ignition plug 142 in the vehicle width direction. Further, the ignition plug 142 (See FIG. 4) is mounted substantially coaxially with the cylinder axis C and disposed in the center of the combustion recessed part 141.

The injectors 143A, 143B have fixed parts 170A, respectively, which are projected in two circumferential directions from the outer periphery of the cylindrical injector body 170. The injectors 143A, 143B are respectively inserted into the injector insert parts 171A, 171B (See FIG. 3) formed below the lower intake ports 145B, and fixed to the cylinder heads 132A, 132B by a plurality of injector fixing bolts 170B penetrating through the fixed parts 170A.

As shown in FIG. 9, the upper parts of the injectors 143A, 143B are respectively provided with injector side fitting nut parts 172, 173 projected toward the fuel chamber 91. The injector side fitting nut parts 172, 173 are connecting parts to which the fuel pipes 92, 93 are respectively connected. The fuel pipes 92, 93 are attached and detached by rotating the injector side fitting nut parts 172, 173 in the state of being inserted in the injector side fitting nut parts 172, 173.

Since the injector side fitting nuts 172, 173 are respectively projected from the injector body 170 for the substantially same length, the end faces 172A, 173A of the injector side fitting nut parts 172, 173 are located to shift from each other by the offset amount Y.

As shown in the side view of FIG. 3, the front fitting part 97 and the rear fitting part 98 at the lower end part 91B of the fuel chamber 91 are disposed facing the injector side fitting nut parts 172, 173, respectively. The front fitting part 97 and the rear fitting part 98 are respectively mounted to be substantially coincident with the injector side fitting nut parts 172, 173 at positions in the longitudinal direction and height direction of the vehicle, and disposed to overlap each other. Further, the front fitting part 97 and the rear fitting part 98, and the injector side fitting nut parts 172, 173 are located in the center in the longitudinal direction of the V-bank space K, and located at the inward side more than the front and rear lower intake ports 145B in the V-bank space K in the longitudinal direction of the vehicle.

As shown in FIG. 9, one end of the fuel pipe 92 is connected to the fitting nut part 97A of the front fitting part 97 and the other end thereof is connected to the injector side fitting nut part 172. Further, one end of the fuel pipe 93 is connected to the fitting nut part 98A of the rear fitting part 98 and the other end thereof is connected to the injector side fitting nut part 173.

Since the front fitting part 97 and the rear fitting part 98 and the injector side fitting nut parts 172, 173 are substantially coincident with each other at the positions in the height direction, the fuel pipes 92, 93 are disposed substantially horizontally. Thus, the fuel pipes 92, 93 are substantially horizontal so that the space occupied by the fuel pipes 92, 93 in the V-bank space K can be reduced to dispose the fuel pipes 92, 93 in a compact manner.

The front fitting part 97 is mounted to project toward the air cleaner 41 by the offset amount X according to the offset amount Y of the cylinder bore 135. In this case, the offset amount Y and the offset amount X are set equal to each other, and in the present embodiment, the piping fitting surface 97B is offset from the piping fitting surface 98B by a distance equal to the offset amount Y of the cylinder bore 135 of the front cylinder block 131A.

That is, between the piping fitting surfaces 97B, 98B both extended from the branch part 96, the piping fitting surface 97B is extended for the offset amount Y of the injector 143A, so that the distance between the piping fitting surface 97B and the injector side fitting nut part 172 and the distance between the piping fitting surface 98B and the injector side fitting nut part 173 can be equalized. Thus, the fuel pipe 92 and the fuel pipe 93 can have the same length, so that the fuel pipe 92 and the fuel pipe 93 can be formed using the same pipe to decrease the number of kinds of parts.

The procedure of assembling the fuel feeding device 90 will now be described with reference to FIG. 3 and FIG. 9.

First, in the engine 17 where assembling of the front bank 110A and the rear bank 110B is completed, the injectors 143A, 143B are respectively disposed in the injector insert parts 171A, 171b through the V-bank space K, and the injector fixing bolts 170B are fastened in to fix the injectors 143A, 143B. Subsequently, the fuel pipes 92, 93 are respectively inserted in the injector side fitting nut parts 172, 173 from the left side of the vehicle, and the injector side fitting nut parts 172, 173 are rotated and fastened in by a tool such as a spanner to thereby connect the fuel pipes 92, 93 to the injectors 143A, 143B. In this case, the work can be performed without installing the upper intake ports 145C, so that the work space can be secured to improve the work efficiency.

The fitting nut parts 97A, 98A of the fuel chamber 91 put in the state of being connected to the fuel pump 144 through the fuel piping 144A are inserted in the ends of the fuel pipes 92, 93 extended from the V-bank space K to the left side of the vehicle, and the fitting nut parts 97A, 98A are rotated and fastened in by a tool such as a spanner to thereby connect the fuel chamber 91 and the fuel pipes 92, 93 to each other.

On the other hand, in the case of removing the injectors 143A, 143B, after the fitting nut parts 97A, 98A are detached, the injector side fitting nut parts 172, 173 may be removed, and then the injector fixing bolts 170B may be removed.

In addition, the fuel chamber 91 of the present invention is mounted on the left end side in the vehicle width direction and disposed lengthways in the V-bank space K, so that the fuel chamber 91 occupies the V-bank space K in a low proportion. Thus, a large space can be secured in the V-bank space K on the right side of the fuel chamber 91, and this space can be utilized to use a tool for fastening in or loosening the injector side fitting nut parts 172, 173 and the fitting nut parts 97A, 98A. Therefore, even in the V-bank space K, which becomes narrower as it goes downward, the injector side fitting nut parts 172, 173 and the fitting nut parts 97A, 98A can be fastened in to put the fuel pipes 92, 93 in the connecting state using the tool, so that the injectors 143A, 143B can be mounted in the lower part in the V-bank space K.

Although the engine 17 is constructed like a V-shape so that the bank angle is a contained angle smaller than 90 degrees and the V-bank space K is smaller, also in this case, the injector side fitting nut parts 172, 173 and the fitting nut parts 97A, 98A can be fastened in to put the fuel pipes 92, 93 in the connecting state to mount the injectors 143A, 143B in the lower part in the V-bank space K utilizing the V-bank space K at the side of the fuel chamber 91.

Further, the injectors 143A, 143B can be mounted in the lower part in the V-bank space K and as shown in FIG. 4, the injectors 143A, 143B are mounted below the lower intake ports 145B, so that the space in the center of the combustion recessed part 141 of each cylinder head 132A, 132B can be secured to achieve the center plug system in which the ignition plugs 142 are provided in the central parts of the combustion recessed parts 141.

The engine 17 is a direct injection type engine, and although a high-pressure fuel pressurized by the fuel pump 144 flows through the fuel chamber 91, the fuel pipes 92, 93 and the injectors 143A, 143B, the injectors 143A, 143B can be mounted in the lower part in the V-bank space K by fastening and surely fixing using the injector side fitting nut parts 172, 173 and the fitting nut parts 97A, 98A.

Further, the injector side fitting nut parts 172, 173, the fitting nut parts 97A, 98A and the fuel pipes 92, 93 are located in the center in the longitudinal direction of the V-bank space K and mounted horizontally and parallel in the vehicle width direction, so that the turning range in rotating the tool such as a spanner in the longitudinal direction of the vehicle can be secured around the fuel pipes 92, 93. Thus, the injector side fitting nut parts 172, 173 and the fitting nut parts 97A, 98A can be easily rotated by the tool to improve the work efficiency.

Further, the fitting nut parts 97A, 98A are offset from each other in the vehicle width direction, and the fitting nut parts 97A, 98A do not overlap with respect to the turning direction of the tool for fastening in the fitting nut parts 97A, 98A, so that in rotating the one fitting nut part 97A using the tool, the other fitting nut part 98A does not cause any obstruction to improve the work efficiency. Further, the injector side fitting nut parts 172, 173 are offset from each other in the vehicle width direction, in rotating the one injector side fitting nut part 172 using the tool, the other injector side fitting nut part 173 does not cause any obstruction to improve the work efficiency.

Further, the tool can be used utilizing the V-bank space K at the side of the fuel chamber 91 so that the injector fixing bolts 170B can be easily attached and detached to improve the work efficiency.

The injectors 143A, 143B are mounted below the lower intake ports 145B, so that the injectors 143A, 143B are disposed in the lying state with respect to the cylinder axis C on the intake port 145 side to improve the ignitability of the engine 17. Further, the injector 143 is mounted along the lower intake port 145B, so that the injector 143 is restrained from projecting over the front and rear banks 110A, 110B to miniaturize the front and rear banks 110A, 110B. As a result, the V-bank space K can be enlarged to facilitate the work for attaching and detaching the injectors 143A, 143B.

As described above, according to the embodiment to which the invention is applied, the fuel pump 144 can be driven by the camshaft 152, the fuel pump 144 is mounted on the front bank 110A at the back of the head pipe 12, and the fuel pump 144 is disposed just at the back of the head pipe 12, so that the fuel pump 144 can be surrounded by the main frame 25, the gusset pipe 25A, the head pipe 12, the down pipe 27A and the upper part of the front bank 110A to protect the fuel pump 144 from the external force or the like without a special cover or the like.

Further, the fuel pump 144 is disposed in the dead space at the back of the head pipe 12, so that it does not cause any obstruction to disposition of the other components. Further, the fuel pump 144 is mounted in a position hard to see from the outside at the back of the head pipe 12 and the fuel pump 144 can be disposed not to be conspicuous, so that the appearance can be made clear-cut to improve the appearance of the motorcycle 10.

The fuel pump 144 is mounted on the upside of the front camshaft 152 in the front bank 110A, so that the fuel pump 144 can be disposed just at the back of the head pipe 12, and the fuel pump can be surrounded by the main frame 25, the gusset pipe 25A, the head pipe 12, the down pipe 27A and the upper part of the front bank 110A to protect the fuel pump 144 from the external force or the like without a special cover or the like.

Since the fuel pump can be driven by the camshaft 152 positioned close to the head pipe 12, the advantage is that it is not necessary to lengthen a driving force transmission path between the camshaft and the fuel pump for disposing the fuel pump 144 just at the back of the head pipe 12. In the case of driving the fuel pump 144 just at the back of the head pipe 12 by the camshaft 151, for example, a comparatively long driving force transmission path is needed between the camshaft 151 and the fuel pump 144.

Further, the fuel piping 144A is extended parallel along the top face 133C of the head cover 133A, mounted below the gusset pipe 25A, and surrounded by the top face 133C and the gusset pipe 25A, so that the fuel piping 144A can be protected.

Although the description of the above embodiment is made supposing that the fuel pump 144 is driven by the camshaft 152, this is not restrictive in the invention, but it is enough that the camshaft for driving the fuel pump 144 has the front bank 110A. The fuel pump 144 may be driven by the intake side camshaft 151, and the fuel pump 144 may be mounted above the camshaft 151.

In addition, the injectors 143A, 143B in the lower part in the V-bank space K and the fuel chamber 91 can be connected to each other by the horizontal fuel pipes 92, 93 extended from the lower end 91B of the fuel chamber 91, and the fuel chamber 91 is disposed lengthways in the vertical direction in the V-bank space K, so that a large space can be secured at the right side of the fuel chamber 91 in the V-bank space K. Thus, a tool or the like for attaching and detaching the injector side fitting nut parts 172, 173 and the fitting nut parts 97A, 98A can be used utilizing the space in the V-bank space K, and the fuel pipes 92, 93 connecting the fuel chamber 91 and the injectors 143A, 143B can be assembled so that the injectors 143A, 143B can be disposed in the lower part in the V-bank space K. The front fitting part 97 and the rear fitting part 98 are extended below the lower intake port 145B and provided with the fuel pipes 92, 93, so that the injectors 143A, 143B can be disposed below the lower intake port 145B.

Further, since the fuel pipes 92, 93 can be removed utilizing the space at the right side of the fuel chamber 91 in the V-bank space K, the fuel pipes 92, 93 are removed without detaching the cylinder head 132A to access the injectors 143A, 143B, whereby the maintainability of the fuel feeding device including the injector can be improved.

Further, the fuel chamber 91 and the fuel pipe 144A are provided along the cylinder head 132A and the top face 133C, so that the fuel feeding device 90 can be disposed in a compact manner.

Further, the space in the center of each combustion recessed part 141 of the cylinder heads 132A, 132B can be secured by disposing the injectors 143A, 143B below the lower intake port 145B, and it is possible to achieve the center plug system by providing the ignition plugs 142 in the central parts of the cylinder bores 135 of the cylinder heads 132A, 132B.

Although the description of the above embodiment is made supposing that the fuel chamber 91 is provided at the left end on the opposite side to the air cleaner 41 in the V-bank space K, this is not restrictive in the invention, but it is enough that the fuel chamber 91 is disposed lengthways in the vertical direction in the V-bank space K. For example, the fuel pipes 92, 93 may be shortened to mount the fuel chamber 91 more inside.

As described above, between the fitting nut parts 97A, 98A to which the fuel pipes 92, 93 branching from the lower end part 91B of the fuel chamber 91 in the V-bank space and extending horizontally, the fitting nut part 97A is provided to offset from the fitting nut part 98A. Therefore, in fitting the fuel pipes 92, 93 to the fuel chamber 91, the positions of the piping fitting surfaces 97B, 98B are separate from each other, so that in the work for rotating the fitting nut parts 97A, 98A using the tool, the mutual fitting nut parts 97A, 98A do not cause any obstruction to the fitting work. Thus, even in a narrow space in the V-bank space K, the fuel pipes 92, 93 can be simply fitted to facilitate the fitting work for the fuel feeding device 90.

Since the offset amount X of the piping fitting surface 97B of the fuel chamber 91 is the same as the offset amount Y of the cylinder bore 135, that is, the offset amount Y of the injector 143A, the distance from the piping fitting surface 97B to the injector side fitting nut part 172 and the distance from the piping fitting surface 98B to the injector side fitting nut part 173 can be made equal to each other, and the respective fuel pipes 92, 93 can be equal in length. Thus, the fuel pipes 92, 93 can be constructed using the same fuel pipe to decrease the number of kinds of parts.

Further, since the fuel chamber 91 and the fuel piping 144A are provided along the cylinder head 132A and the top face 133C, the fuel feeding device 90 can be disposed in a compact manner.

Further, the space in the center of each combustion recessed part 141 of the cylinder heads 132A, 132B can be secured by disposing the injectors 143A, 143B below the lower intake port 145B, and it is possible to achieve the center plug system direct injection engine by providing the ignition plugs 142 in the central parts of the cylinder bores 135 of the cylinder heads 132A, 132B.

Although the description of the above embodiment is made supposing that the fuel chamber 91 is provided at the left end on the opposite side to the air cleaner 41 in the V-bank space K, this is not restrictive in the invention, but it is enough that the fuel chamber 91 is disposed lengthways in the vertical direction in the V-bank space K. For example, the fuel pipes 92, 93 may be shortened to mount the fuel chamber 91 more inside. In addition, it goes without saying that the detailed configuration of the motorcycle 10 may be also altered optionally.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A motorcycle mounted with a V-shaped engine having a cylinder block disposed like a V-shape and a fuel pump for fuel injection mounted,
wherein the fuel pump is driven by a camshaft of a cylinder head and provided on the upside of the cylinder head, and the cylinder head to which the fuel pump is fitted is a cylinder head of a front bank at the back of a head pipe.

2. The motorcycle according to claim 1, wherein two camshafts are provided in front and behind in the cylinder head of the front bank, and the fuel pump is driven by the front camshaft and disposed above the front camshaft.

3. The motorcycle according to claim 1, wherein the cylinder head of the front bank is disposed at the back of the head pipe and surrounded by a main frame and a down tube.

4. The motorcycle according to claim 2, wherein the cylinder head of the front bank is disposed at the back of the head pipe and surrounded by a main frame and a down tube.

5. The motorcycle according to claim 1, wherein a fuel chamber is provided between the fuel pump disposed on the cylinder head of the front bank and a fuel injector, the fuel chamber is disposed lengthways in the vertical direction in a V-bank, an upper end part is disposed facing the upside of the cylinder head cover, and connected to the fuel pump by fuel piping raised from the upper end part and extending substantially parallel to the top face of the cylinder head cover, and the fuel piping is disposed below a gusset pipe.

6. The motorcycle according to claim 2, wherein a fuel chamber is provided between the fuel pump disposed on the cylinder head of the front bank and a fuel injector, the fuel chamber is disposed lengthways in the vertical direction in a V-bank, an upper end part is disposed facing the upside of the cylinder head cover, and connected to the fuel pump by fuel piping raised from the upper end part and extending substantially parallel to the top face of the cylinder head cover, and the fuel piping is disposed below a gusset pipe.

7. The motorcycle according to claim 3, wherein a fuel chamber is provided between the fuel pump disposed on the cylinder head of the front bank and a fuel injector, the fuel chamber is disposed lengthways in the vertical direction in a V-bank, an upper end part is disposed facing the upside of the cylinder head cover, and connected to the fuel pump by fuel piping raised from the upper end part and extending substantially parallel to the top face of the cylinder head cover, and the fuel piping is disposed below a gusset pipe.

8. The motorcycle according to claim 4, wherein a fuel chamber is provided between the fuel pump disposed on the cylinder head of the front bank and a fuel injector, the fuel chamber is disposed lengthways in the vertical direction in a V-bank, an upper end part is disposed facing the upside of the cylinder head cover, and connected to the fuel pump by fuel piping raised from the upper end part and extending substantially parallel to the top face of the cylinder head cover, and the fuel piping is disposed below a gusset pipe.

9. A fuel feeding device of a V-shaped engine in which a cylinder block is disposed like a V-shape and fuel is fed to an injector in a V-bank from a fuel pump driven by a cam shaft of a cylinder head and mounted on the cylinder head,
wherein a fuel chamber is provided between the fuel pump and the injector, the fuel chamber is disposed lengthways in the vertical direction in the V-bank, and a lower end part is disposed facing the side of the injector, and connected to the injector by a fuel pipe extending from the lower end part substantially horizontally.

10. The fuel feeding device of a V-shaped engine according to claim 9, wherein the fuel chamber is extended upward substantially parallel to the cylinder head rather closer to the side of the cylinder head to which the fuel pump is mounted, and an upper end part is disposed facing the upside of a cylinder head cover, and connected to the fuel pump by fuel piping raised from the upper end part and extending substantially parallel to the top face of the cylinder head cover.

11. The fuel feeding device of a V-shaped engine according to claim 9, wherein the injector is disposed below an intake port and constructed to inject fuel directly to a combustion chamber.

12. The fuel feeding device of a V-shaped engine according to claim 9, wherein the fuel pump is provided on the cylinder head, the fuel chamber is extended upward substantially parallel to the cylinder head rather closer to the cylinder head on which the fuel pump is mounted, and an upper end part is disposed facing an upside of cylinder head cover, and connected to the fuel pump mounted on the cylinder head by fuel piping raised from the upper end part and extending substantially parallel to a top face of the cylinder head cover.

13. The fuel feeding device of a V-shaped engine according to claim 10, wherein the fuel pump is provided on the cylinder head, the fuel chamber is extended upward substantially parallel to the cylinder head rather closer to the cylinder head on which the fuel pump is mounted, and an upper end part is disposed facing an upside of cylinder head cover, and connected to the fuel pump mounted on the cylinder head by fuel piping raised from the upper end part and extending substantially parallel to a top face of the cylinder head cover.

14. The fuel feeding device of a V-shaped engine according to claim 9, wherein the fuel chamber is disposed lengthways in a vertical direction in the V-bank, a lower end part of the fuel chamber is disposed facing the side of the injector, and connected to the injector provided in each cylinder block by a fuel pipe branching from the lower end part and extending substantially horizontally, and a piping fitting surface is offset by projecting one fuel pipe fitting part of the fuel chamber over the other fuel pipe fitting part.

15. The fuel feeding device of a V-shaped engine according to claim 10, wherein the fuel chamber is disposed lengthways in a vertical direction in the V-bank, a lower end part of the fuel chamber is disposed facing the side of the injector, and connected to the injector provided in each cylinder block by a fuel pipe branching from the lower end part and extending substantially horizontally, and a piping fitting surface is offset by projecting one fuel pipe fitting part of the fuel chamber over the other fuel pipe fitting part.

16. The fuel feeding device of a V-shaped engine according to claim 14, wherein the offset amount of the piping fitting surface is the same as the offset amount of an opposite cylinder.

17. The fuel feeding device of a V-shaped engine according to claim 14, wherein the fuel pump is provided on the cylinder head, the fuel chamber is extended upward substantially parallel to the cylinder head rather closer to the cylinder head on which the fuel pump is mounted, and an upper end part is disposed facing an upside of cylinder head cover, and connected to the fuel pump mounted on the cylinder head by fuel piping raised from the upper end part and extending substantially parallel to a top face of the cylinder head cover.

18. The fuel feeding device of a V-shaped engine according to claim 15, wherein the fuel pump is provided on the cylinder head, the fuel chamber is extended upward substantially parallel to the cylinder head rather closer to the cylinder head on which the fuel pump is mounted, and an upper end part is disposed facing an upside of cylinder head cover, and connected to the fuel pump mounted on the cylinder head by fuel piping raised from the upper end part and extending substantially parallel to a top face of the cylinder head cover.

19. The fuel feeding device of a V-shaped engine according to claim 14, wherein the injector is disposed below an intake port and constructed to inject fuel directly to a combustion chamber.

20. The fuel feeding device of a V-shaped engine according to claim 15, wherein the injector is disposed below an intake port and constructed to inject fuel directly to a combustion chamber.
